(19) United States
(12) Patent Application Publication
(10) Pub. No.: US 2003/0123725 A1
(43) Pub. Date: Jul. 3, 2003

(54) Image file including transparency data

(76) Inventor: Hideyuki Narusawa, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/264,310

(22) Filed: Oct. 2, 2002

(30) Foreign Application Priority Data
Oct. 4, 2001 (JP) 2001-308576(P)

(51) Int. Cl. G06K 9/36; G06K 9/00

(52) U.S. Cl. 382/166; 382/232

(57) ABSTRACT

The object of the invention is to provide an image file that is capable of defining a transparent part in a multi-colored image.

The technique of the invention generates image data, which includes, with regard to each pixel, tone values of a color and a transparency parameter to regulate a degree of transparency in multiple stages. The technique then compresses the generated image data in a preset compression format, for example, a JPEG format, to generate an image file. This arrangement specifies the color by the tone values and the degree of transparency by the transparency parameter with regard to each pixel, thus attaining expression of diverse colors and multistage degrees of transparency. The color may be monochromatic or polychromatic and may be expressed by any color system.

### BACKGROUND OF THE INVENTION

1. Field of the Invention

The present invention relates to generation of an image file including a transparent part and to output of an image according to such an image file.

2. Description of the Related Art

There are a variety of known editing programs used to edit and print documents with images attached thereto. The editing program enables a partly transparent image to be superimposed on a certain background image. This function may be utilized to superimpose a separately prepared frame image on a photograph and thereby generate a framed photograph image.

A preferable procedure stores an image file corresponding to an image to be superimposed on another photograph, such as a frame image, after defining part of the image as ‘transparent’. A transparent GIF is a known image file that is capable of treating ‘transparent’. The GIF defines the color of each pixel according to a preset color palette. One color in the color palette is identified as transparent shade. A header has a transparency flag, which specifies whether or not the color identified as the transparent shade should be regarded as ‘transparent’. For example, when ‘white’ is identified as the transparent shade, an image area expressed with ‘white’ is regarded as ‘transparent’ in the ON state of the transparency flag, but is regarded as normal ‘white’ in the OFF state of the transparency flag.

In the GIF, however, the number of colors usable for the image is limited by the color pallet. The GIF is thus not applicable to multicolored images like natural images. The GIF is capable of defining only two states, that is, a complete transparent state and a complete opaque state, and can not define any translucent state.

### SUMMARY OF THE INVENTION

The object of the present invention is thus to provide an image file that is capable of defining a transparent part in a multicolored image.

In order to solve the problem discussed above, the technique of the present invention generates image data, which includes, with regard to each pixel, tone values of a color and a transparency parameter to regulate a degree of transparency in multiple stages. The technique then compresses the generated image data in a preset compression format to generate an image file. This arrangement specifies the color by the tone values and the degree of transparency by the transparency parameter with regard to each pixel, thus attaining expression of diverse colors and multistage degrees of transparency. The multistage degrees mean that there is at least one state in addition to the completely transparent state and the completely opaque state. One available procedure sets a large number of applicable values for the transparency parameter and varies the degree of transparency in a continuous manner. Another available procedure sets a relatively small number of applicable values for the transparency parameter and varies the degree of transparency in a discrete manner. The color may be monochromatic or polychromatic and may be expressed by any color system.

In the image file of the present invention, the transparency parameter is preferably an alpha channel. The alpha channel is an auxiliary channel used for image processing. In the case of 32-bit image processing, for example, each of three color components is processed by 8 bits, that is, totally by 24 bits, and the remaining 8 bits are used as the alpha channel. The alpha channel may not have the same number of bits as those of the three color components. Application of this alpha channel for the transparency parameter ensures efficient image processing.

A variety of compression formats are applicable for the image file of the present invention. Especially preferable is compression in a JPEG format. Unlike the GIF, the JPEG format is suitable for compression of multi-colored images.

It is desirable to carry out compression of the transparency parameter in the JPEG format under a preset restriction condition, which relates to a sampling factor and a quantization table and is specified according to relations to the other color components.

The JPEG format generally uses the YCbCr color system and causes a sampled image with a predetermined sampling factor to be subjected to compression. One preferable embodiment of the present invention applies an identical sampling factor for the transparency parameter and the Y component of the YCbCr color system.

The JPEG format uses quantization tables to reduce the quantity of information. It is desirable that a different quantization table is applied for the transparency parameter from those applied for the other color components.

When an image is output according to the image file of the invention, the procedure sets an output tone value of each pixel according to a predetermined computation of tone values of each pixel in the image file and in background image data, which is located behind the image file in a resulting output, and the transparency parameter. This arrangement ensures expression of the multistage degrees of transparency according to the transparency parameter.

The predetermined computation may be a non-linear function of the transparency parameter, but a linear function is preferable because of its easy processing.

The technique of the present invention is actualized by a diversity of other applications, for example, an image file generation device that generates the image file discussed above, a method of generating such an image file, a computer program used for generating such an image file, and a recording medium in which such a program is recorded. Other applications include an image output device that outputs an image according to such an image file, a method of outputting an image, a computer program used for outputting an image, and a recording medium in which such a program is recorded.

Available examples of the recording media include flexible disks, CD-ROMs, magneto-optic discs, IC cards, ROM cartridges, punched cards, prints with barcodes or other codes printed thereon, internal storage devices (memories like a RAM and a ROM) and external storage devices of the computer, and a variety of other computer readable media.

### BRIEF DESCRIPTION OF THE DRAWINGS

FIG. 1 schematically illustrates the construction of an image file processing device in one embodiment;

FIG. 2 shows the general structure of an EFF format;

FIG. 3 shows the structure of basic information included in an EFF header segment;

FIG. 4 shows the structure of extra information included in the EFF header segment;

FIG. 5 shows Fitting rules;

FIG. 6 shows Alignment rules;

FIG. 7 shows the structure of a thumbnail header;

FIG. 8 shows an exemplified construction of a whole file in the embodiment;

FIG. 9 shows the exemplified construction of the whole file in the embodiment;

FIG. 10 shows the exemplified construction of the whole file in the embodiment; and

FIG. 11 shows the exemplified construction of the whole file in the embodiment.

### DESCRIPTION OF THE PREFERRED EMBODIMENTS

One mode of carrying out the present invention is discussed below in the following sequence:

A. System Construction

B. EFF Format

A. System Construction

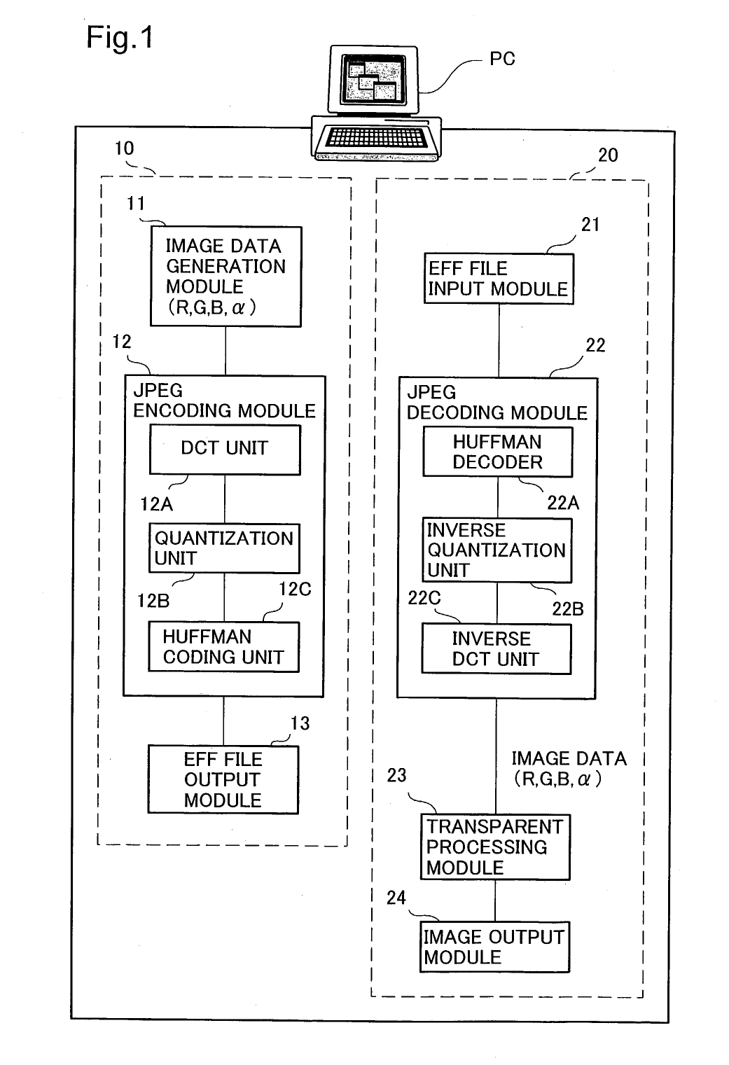

FIG. 1 schematically illustrates the construction of an image file processing device in one embodiment. In this embodiment, the device is arranged by installing software for generating an image file and software for outputting an image according to the generated image file in a general-purpose personal computer PC. The software is read from a CD-ROM or another recording medium or is fetched via the Internet or another network to be installed. The single personal computer PC attains the functions as both of an image file generation device and an image output device in this embodiment, but the functions of these two devices may be actualized by physically separate devices.

Functional blocks as the file generation device and as the image output device are shown in the drawing. These functional blocks are constructed by the software.

A file generation module 10 attains the functions as the file generation device. The file generation module 10 has an image data generation module 11 that generates image data working as original data of an image file. The image data with regard to each pixel includes tone values of red (R), blue (B), and green (G) to express a color, and an alpha (α) channel to define a degree of transparency. In this embodiment, each tone value of R, G, and B is expressed as 8-bit data (0 to 255), and the α value is also expressed as 8-bit data (0 to 255). The α value of ‘0’ shows that the pixel is completely opaque. The α value of ‘255’ shows that the pixel is completely transparent. The intermediate α values represent the varying degree of transparency in multiple stages. The bit number of each color component may be defined arbitrarily. The color expression is not restricted to the RGB color system, but any of diverse color systems is applicable. The image data generation module 11 may be constructed to input original image data expressed by the RGB color system and add the α value to each pixel of the original image data.

The image data thus generated is compressed into a JPEG format by means of a JPEG encoding module 12. The JPEG encoding module 12 has several functional blocks to implement the compression, a DCT unit 12A that carries out discrete cosine transform, a quantization unit 12B that refers to a quantization table and reduce the quantity of information, and a Huffman coding unit 12C that carries out Huffman encoding. In the process of JPEG compression, the image data is converted from the RGB color system to the YCbCr color system. The JPEG compression is a known technique and is thus not specifically described here.

In the specification hereof, the image file subjected to the JPEG compression is called an EFF (enhanced frame file). An EFF file output module 13 outputs the resulting EFF file to the hard disk, a memory card, or another suitable recording medium.

An image output module 20 attains the functions as the image output device. An EFF file input module 21 inputs the EFF file. The input EFF file is decoded by a JPEG decoder module 22. A Huffman decoder 22A first carries out Huffman decoding. An inverse quantization unit 22B then converts the decoded file into data in a frequency domain. An inverse DCT unit 22C subsequently carries out inverse discrete cosine transform to convert the data in the frequency domain into tone data. In this process, the image data is reconverted from the YCbCr color system to the RGB color system.

The resulting image data has the tone values of R, G, and B and the α value with regard to each pixel. A transparent processing module 23 carries out transparent processing according to the α value. The transparent processing specifies the tone values of each pixel according to equations given below:

Ra={Rt×α+R×(255−α)}/255;

Ga={Gt+α+G×(255−α)}/255;

Ba={Bt+α+B×(255−α)}/255;

Ra, Ga, Ba: tone values of a resulting composite image

Rt, Gt, Bt: tone values of an underlaid image

R, G, B: tone values of an overlaid image

α: α value

The underlaid image represents a background in the case of outputting an image file in this embodiment. The underlaid image may be a background color area or another image prepared separately. An image output module 24 outputs the resulting image by various means, for example, by printing or by displaying.

In the case of printing, the generated image is output according to the following procedure.

The image output module 24 inputs specified dimensions of a printing sheet and specifies the position and the size of a printing area, in which the image data is to be printed. In the case where the specified size of the printing area is different from the size of the image, the size of the image should be adjusted to fit the size of the printing area. The adjustment is executed in conformity with Fitting rules and Alignment rules discussed later. An instruction of such adjustment may be set according to a layout definition script stored separately in a memory card or may be set manually through operations of a control panel on a printer main body.

The image output module 24 then specifies the presence or the absence of any image data to be combined with the processed image data. When two or more image data are combined together, the images are arranged in a relative manner according to the Fitting rules and the Alignment rules recorded in a header of the EFF file as discussed later. When a trimming instruction is given, the images to be combined are trimmed in an area defined by the coordinates specified by the header of the EFF file. The layout of one of the images to be combined on the printing sheet has already been specified. This series of processing specifies the layout of the other image on the printing sheet.

In the case of combining two or more images, the tone values of the respective pixels are specified according to the above equations that take into account the alpha channel.

On completion of the layout and the combination of the images to be printed, the image output module 24 actually causes the printer to print the resulting composite image.

B. EFF Format

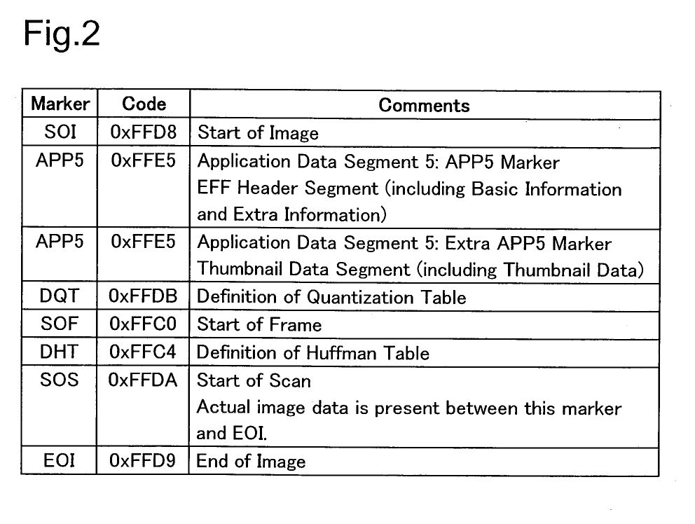

The following describes the EFF format used in this embodiment. FIG. 2 shows the general structure of the EFF format. The EFF format defines the α values processible in the range of the JPEG standard. As illustrated, the EFF format is constructed by segments including markers as identifiers and subsequent parameters.

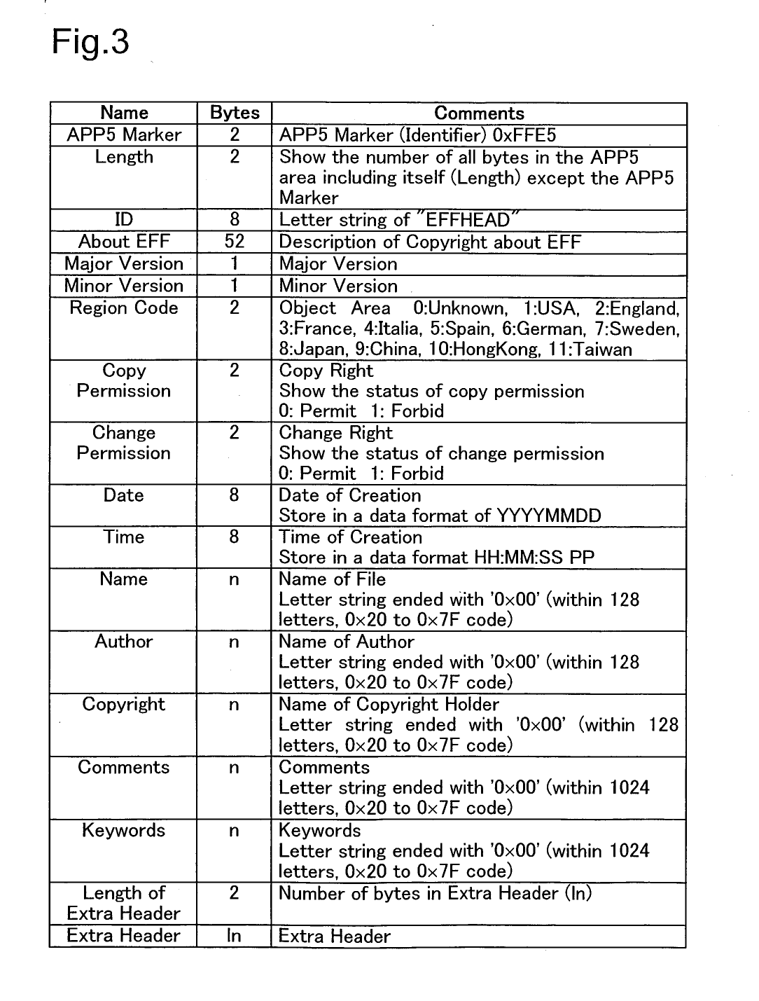

FIG. 3 shows the structure of basic information included in an EFF header segment. This segment declares the EFF file.

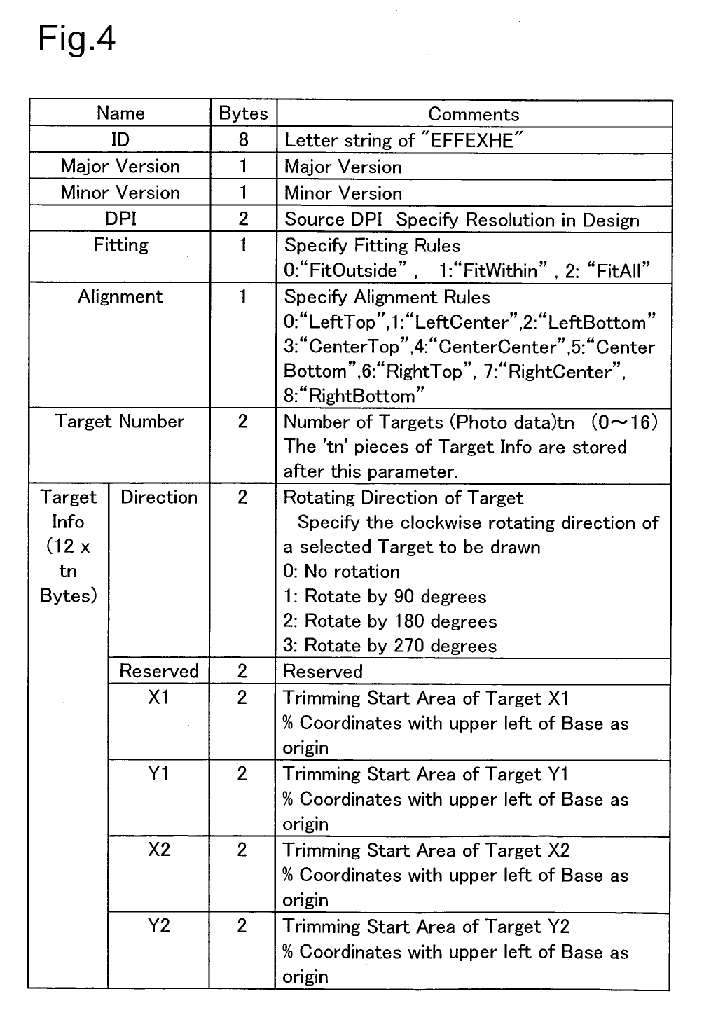

FIG. 4 shows the structure of extra information included in the EFF header segment. The extra information is optionally included in an extra header shown on the last line of FIG. 3. In the structure of the embodiment, information intrinsic to the EFF may be included in the extra header. As described previously, the EFF file is often applied to an image that includes a transparent part and is superimposed on another image like a picture frame. The extra header may thus include information used for specifying the procedure of superimposition. Typical examples of such information include the Fitting rules and the Alignment rules.

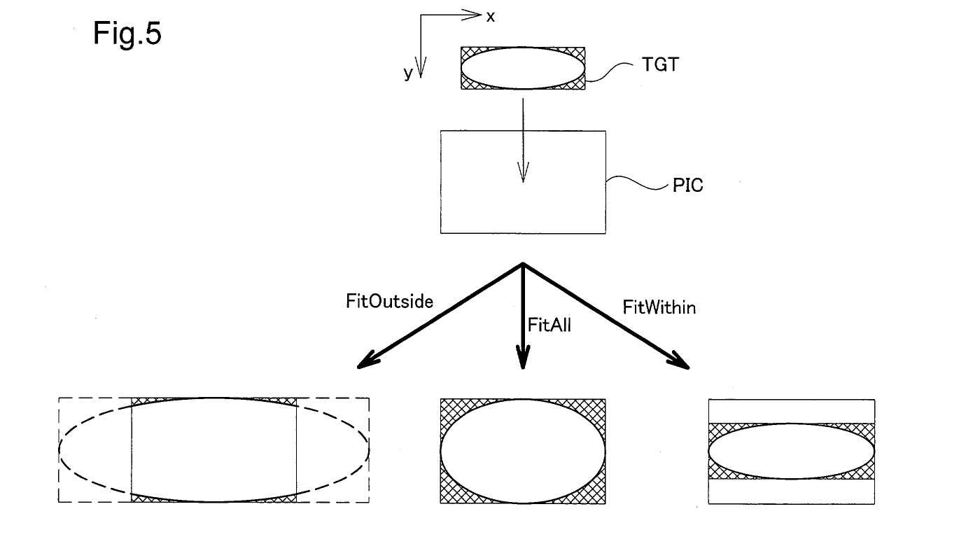

FIG. 5 shows the Fitting rules. In this example, photograph data TGT called a Target is combined with an EFF image PIC. The size and the aspect ratio of the photograph data are different from those of the image PIC. In this case, the procedure of the embodiment changes the size and the aspect ratio of the photograph data TGT to fit the size and the aspect ratio of the image PIC. Three rules FitOutside, FitAll, and FitWithin are applied for the change.

The rule FitOutside changes the size of the photograph data TGT to set the photograph data TGT over the whole surface of the image PIC, while maintaining the aspect ratio of the photograph data TGT. Namely the X direction and the Y direction have an identical magnification. In the case where the aspect ratio of the photograph data TGT is different from the aspect ratio of the image PIC, either the left and right ends or the upper and lower ends of the photograph data TGT are cut before the layout.

The rule FitWithin changes the size of the photograph data TGT to set the whole photograph data TGT in the image PIC, while maintaining the aspect ratio of the photograph data TGT. In the case where the aspect ratio of the photograph data TGT is different from the aspect ratio of the image PIC, margins are set on either of the left and right sides or the upper and lower sides of the image PIC.

The rule FitAll changes the size of the photographic data TGT to make the size of the photographic data TGT coincident with the size of the image PIC. In the case where the aspect ratio of the photograph data TGT is different from the aspect ratio of the image PIC, the X direction and the Y direction have different magnifications. The photograph data TGT is thus magnified either in the horizontal direction or in the vertical direction.

The rules FitOutside and FitWithin allow the positional relationship between the original image PIC and the resulting processed image PIC to have some degree of freedom. The procedure of the embodiment specifies nine settings for the positional relationship as the Alignment rules.

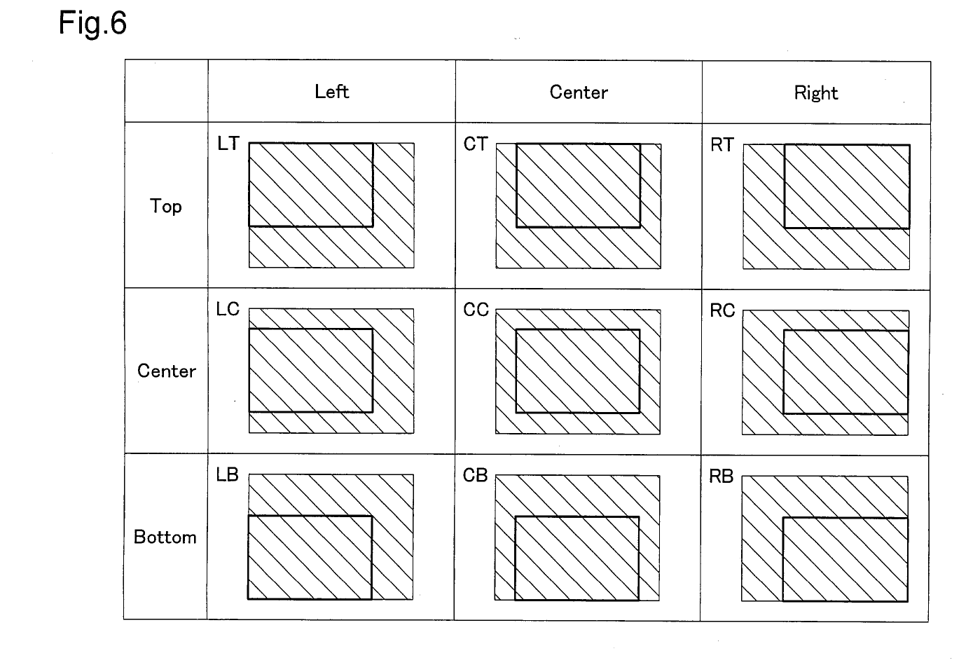

FIG. 6 shows the Alignment rules. Each hatched portion represents the photograph data TGT, and each rectangle included in the hatched portion represents the EFF image. For the better understanding of the relative positional relation, the size of the photograph data is greater than the size of the EFF image in this embodiment. In the case of changing the size of the image according to the rule FitOutside and according to the rule FitWithin, the nine settings for the positional relationship may include the relative positional relations that have practically the same printing results.

The positional relation between the photograph data and the EFF image is defined by reference points set in the photograph data and the EFF image. The output layout of the photograph data and the EFF image is determined to make the two reference points coincident with each other. In this embodiment, combinations of three positions for the reference point in the vertical direction, ‘Top’, ‘Center’, and ‘Bottom’ with three positions for the reference point in the horizontal direction, ‘Left’, ‘Center’, and ‘Right’ give the total of nine settings for the positional relationship. For example, in the case of positional relation LT (Left-Top), the reference points are set at the upper left vertexes of the photograph frame and the image. For the other eight settings, the reference point is similarly defined by the combination of the position in the vertical direction with the position in the horizontal direction. In this embodiment, the three positions are specified for the reference point both in the vertical direction and in the horizontal direction. Any greater number of positions may be specified for the reference point.

As shown in FIG. 4, the rotating direction and trimming of the photograph data may be defined in the extra header of the EFF format.

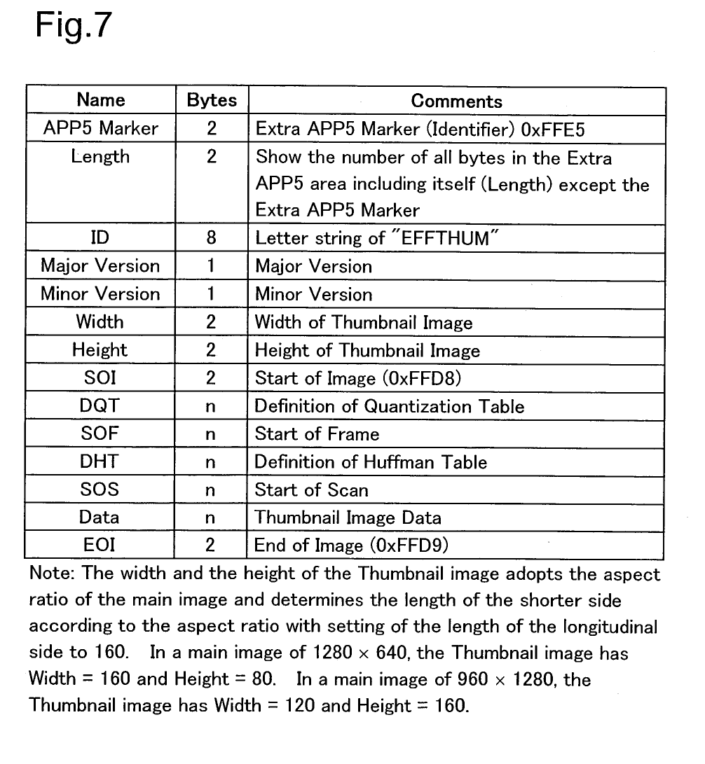

FIG. 7 shows the structure of a thumbnail header. In this embodiment the thumbnail image may include or may not include the α value.

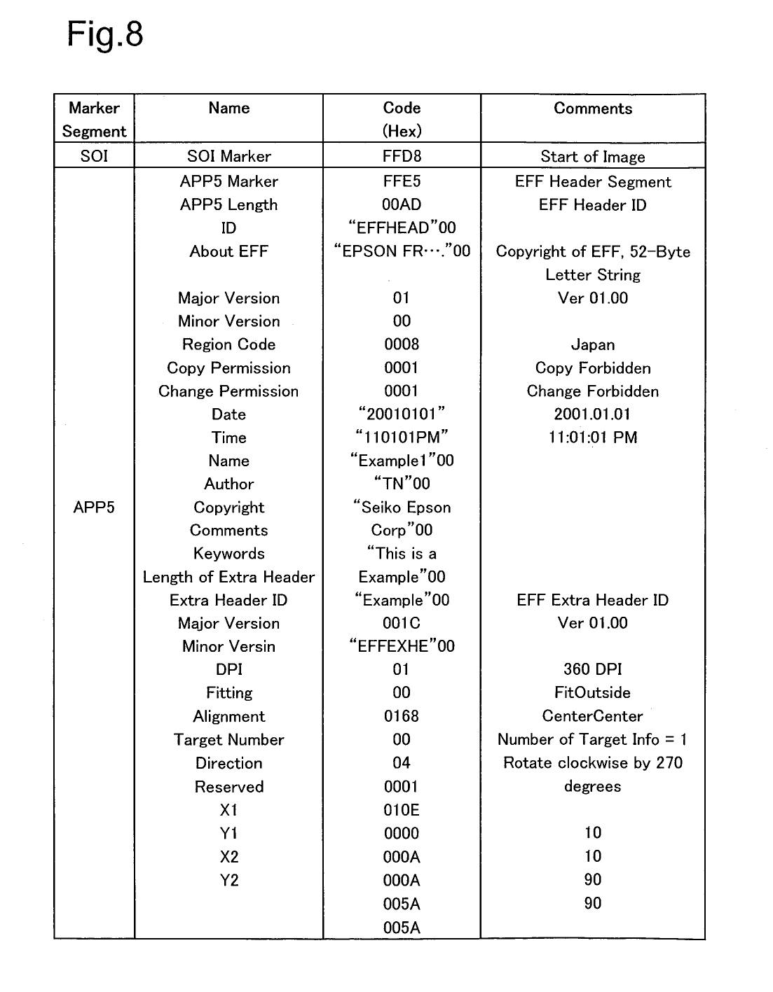

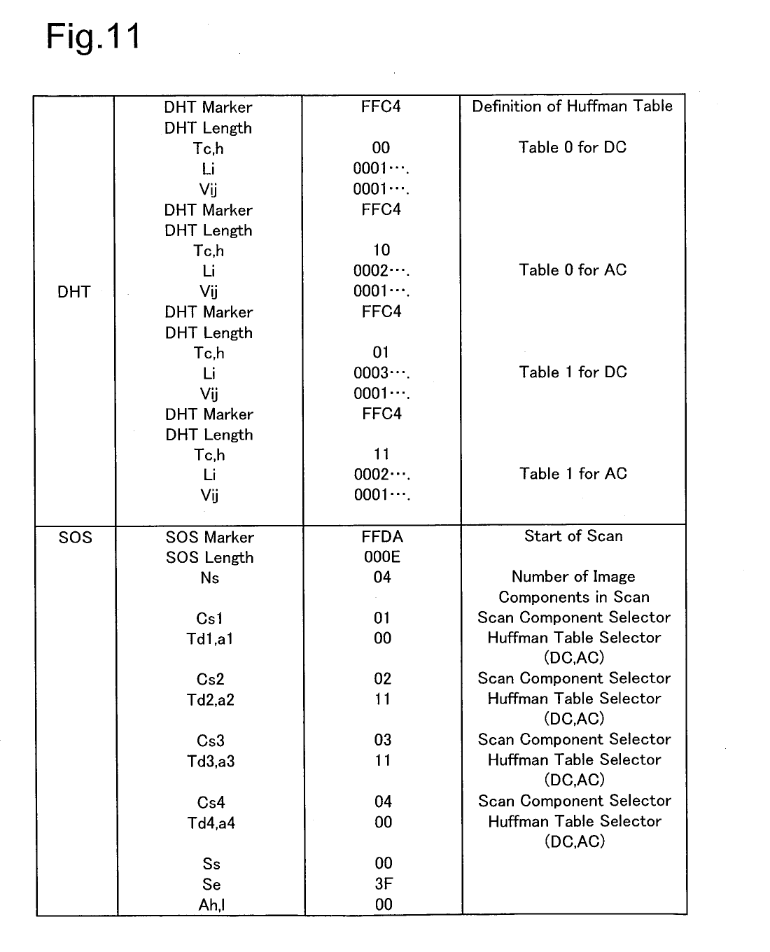

FIGS. 8 through 11 show an exemplified construction of the whole file in this embodiment. A series of data shown in FIGS. 8 through 11 constructs one file.

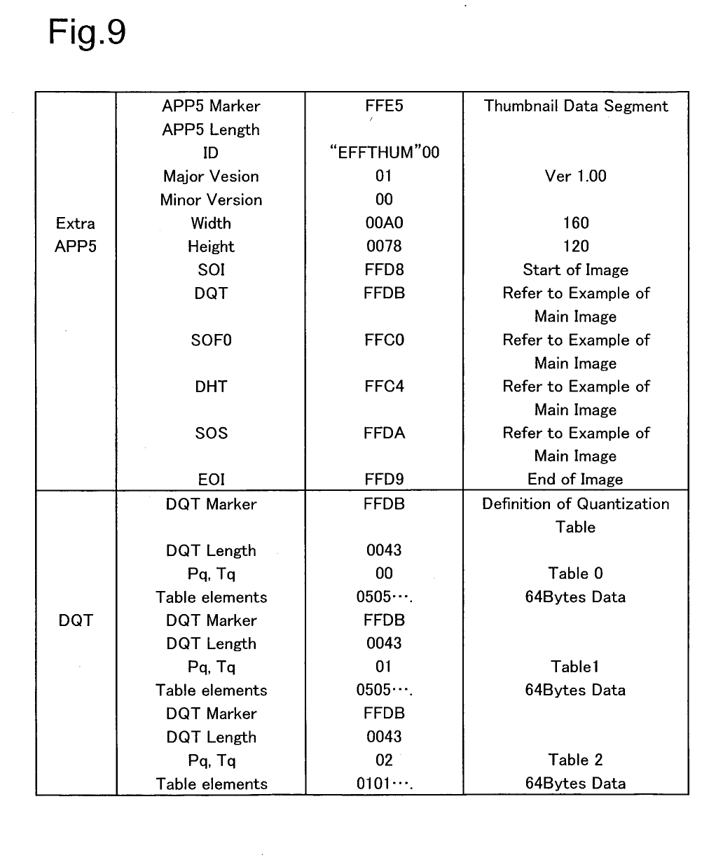

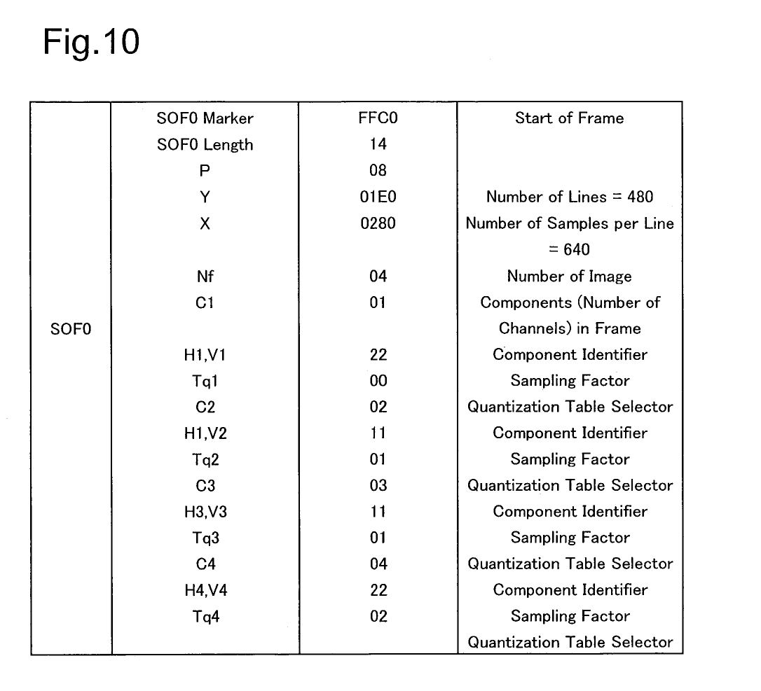

Referring to FIG. 9, a marker DQT, definition of quantization table, defines three quantization tables. These quantization tables are selectively used corresponding to the channels of the image by a quantization table selector shown in FIG. 10. The procedure of this embodiment processes the image of 4 channels, that is, Y, Cb, Cr, and α components, as clearly shown by a parameter Nf. The first channel C1, the second channel C2, the third channel C3, and the fourth channel Y respectively correspond to the Y component, the Cb component, the Cr component, and the αcomponent. As shown in FIG. 10, the quantization table selector (Tqi) assigns a value ‘00’ to the channel C1, a value ‘01’ to the channels C2 and C3, and a value ‘02’ to the channel C3.

Referring to FIG. 10, the procedure of the embodiment allocates sampling factors Hi, Vi(i=1 to 4) ‘22’ to the channel C1, ‘11’ to the channels C2 and C3, and ‘22’ to the channel C4. Namely an identical sampling factor is applied for the luminance component (Y) and the degree of transparency (α).

As described above, separate quantization tables are allocated to the luminance component (Y), the hue components (Cb,Cr), and the degree of component (α), while an identical sampling factor is applied for the Y component and the α component. This arrangement ensures adequate quantization by taking into account the visual effects of the respective components. These settings are arbitrary. One possible modification may apply only either one of the settings of the quantization table and the settings of the sampling factor.

The image file of the embodiment is capable of expressing a diversity of colors and multistage degrees of transparency.

The above embodiment and its modifications are to be considered in all aspects as illustrative and not restrictive. There may be many modifications, changes, and alterations without departing from the scope or spirit of the main characteristics of the present invention. For example, the series of control processing discussed above may be actualized by a hardware configuration, instead of the software.

What is claimed is:

1. An image file generation device that generates an image file including a transparent part, said image file generation device comprising:
an image data generation module that generates image data, which includes, with regard to each pixel, tone values of a color and a transparency parameter to regulate a degree of transparency in multiple stages; and
an compression module that compresses the generated image data in a JPEG format,
wherein said compression module carries out compression of the transparency parameter under a preset restriction condition, which relates to a sampling factor and a quantization table and is specified according to relations to the other color components.

2. An image file generation device in accordance with claim 1, wherein the transparency parameter is expressed by an alpha channel.

3. An image file generation device in accordance with claim 1, said image file generation device further comprising a composite information generation module that generates composite information, which defines a method of combining the image with another image data, as information included in the image file.

4. An image file generation device in accordance with claim 1, wherein the restriction condition applies an identical sampling factor for the transparency parameter and a Y component of a YCbCr color system.

5. An image file generation device in accordance with claim 1, wherein the restriction condition applies a different quantization table for the transparency parameter from those for the other color components.

6. An image output device that outputs an image according to an image file, which includes a transparency parameter representing a degree of transparency with regard to each pixel, said image output device comprising:
an image file input module that inputs the image file;
a background input module that inputs background image data, which is to be located behind the image file in a resulting output; and
an image processing module that sets an output tone value of each pixel according to a predetermined computation of tone values of each pixel in the image file and in the background image data and the transparency parameter.

7. An image output device in accordance with claim 6, wherein the predetermined computation is a linear function of the transparency parameter.

8. An image output device in accordance with claim 6, wherein the image file includes composite information, which defines a method of combining the image file with another image data, and
said image processing module combines the image file with the background image data based on the composite information.

9. A method of generating an image file including a transparent part, said image file generation method comprising the steps of:
generating image data, which includes, with regard to each pixel, tone values of a color and a transparency parameter to regulate a degree of transparency in multiple stages; and
compressing the generated image data in a JPEG format,
wherein said compressing step carries out compression of the transparency parameter under a preset restriction condition, which relates to a sampling factor and a quantization table and is specified according to relations to the other color components.

10. A computer readable recording medium, in which a computer program used for generating an image file including a transparent part is recorded, said computer program causing a computer to attain the functions of:
generating image data, which includes, with regard to each pixel, tone values of a color and a transparency parameter to regulate a degree of transparency in multiple stages; and
compressing the generated image data in a JPEG format under a preset restriction condition with regard to the transparency parameter, which relates to a sampling factor and a quantization table and is specified according to relations to the other color components.

11. A computer readable recording medium, in which a computer program used for outputting an image according to an image file, which includes a transparency parameter representing a degree of transparency with regard to each pixel, said computer program causing a computer to attain the functions of:
inputting the image file;
inputting background image data, which is to be located behind the image file in a resulting output; and
setting an output tone value of each pixel according to a predetermined computation of tone values of each pixel in the image file and in the background image data and the transparency parameter.
